(19) United States
(12) Patent Application Publication
(10) Pub. No.: US 2019/0124290 A1
(43) Pub. Date: Apr. 25, 2019

(54) Dashboard Camera

(71) Applicant: Shenzhen Matego Electronics Technology Co., Ltd., Shenzhen (CN)

(72) Inventor: Ma Yuan, Shenzhen (CN)

(21) Appl. No.: 15/789,821

(22) Filed: Oct. 20, 2017

(51) Int. Cl. H04N 5/91; H04N 5/907; H04N 5/63; B60R 11/04

(52) U.S. Cl. CPC H04N 5/91; H04N 5/907; B60R 2011/0005; B60R 11/04; H04N 5/63

(57) ABSTRACT

A dashcam configured to continuously record video during operation thereof is equipped with a sensor that, when activated by a user, causes a processor of the dashcam to create, from the continuously recorded video, a video clip that is stored separately from the continuously recorded video and that may be transmitted from the dashcam via a wireless transceiver.

### FIELD OF THE DISCLOSURE

The present disclosure relates to cameras, and more particularly to cameras configured to record video of the view in front of a vehicle.

### BACKGROUND

Dashboard cameras, or dashcams, are widely used in some regions of the world. Traditional dashcams are configured to be mounted to the windscreen or dashboard of a vehicle, in a position where the dashcam can record video of the view in front of the vehicle. Such video may be used, for example, by vehicle operators to protect against insurance fraud and corruption by government authorities, and to obtain video evidence of road rage incidents, accidents, and other unpredictable events.

Dashcams are typically configured to continuously record video, which reduces the likelihood that an unexpected or unpredicted event will not be recorded. However, because dashcams have limited data storage capability, previously recorded video is overwritten with newly recorded video once the memory has reached full capacity. Thus, only the most recently recorded video may be retrieved from the dashcam memory. The size of the dashcam memory determines how long video of a given event will remain in the dashcam memory before being written over. For example, some dashcams may be capable of storing 30 minutes of video, such that only the most recent 30 minutes of recorded video may be retrieved from the memory of the dashcam at any given time. Other dashcams may be capable of storing 1 hour, 90 minutes, 2 hours, or some other length of recorded video, with corresponding increases in the length of recent video that may be retrieved from such memory.

### SUMMARY

The present disclosure is directed to a dashboard camera that is equipped to detect an input from a vehicle operator and, based on the input, create a video clip from the continuously recorded video. The video clip may also be transmitted to a predetermined location via an available network or point-to-point connection.

According to one embodiment of the present disclosure, a dashcam comprises: a video camera; a snipping sensor; a wireless transceiver; a processor; and a memory having a primary data storage section and an auxiliary video storage section. The memory also stores instructions for execution by the processor that, when executed by the processor, cause the processor to: continuously operate the video camera to record video when the dashcam is powered on; store the continuously recorded video in the primary data storage section; receive a signal from the snipping sensor at a first time; generate, from video recorded by the video camera and beginning at a second time based on the first time, a video clip; and store the video clip in the auxiliary video storage section.

The memory may store additional instructions for execution by the processor that, when executed by the processor, cause the processor to transmit the stored video clip via the wireless transceiver. The memory may store additional instructions for execution by the processor that, when executed by the processor, cause the processor to overwrite previously recorded video with recently recorded video in the primary data storage section when the primary data storage section is full. The video clip may end a predetermined length of time after the first time. The memory may store additional instructions for execution by the processor that, when executed by the processor, cause the processor to receive a second signal from the snipping sensor at a third time later than the first time and the second time, and the video clip may end at the third time.

The second time may be before the first time. The dashcam may further comprise an accelerometer. The dashcam may further comprise an indicator light. The memory may store additional instructions for execution by the processor that, when executed by the processor, cause the processor to illuminate the indicator light upon receipt of the signal. The memory may store additional instructions for execution by the processor that, when executed by the processor, cause the processor to cause the indicator light to flash for a predetermined period of time prior to a third time that is after the first time and the second time. The memory may also store additional instructions for execution by the processor that, when executed by the processor, cause the processor to: receive a second signal from the snipping sensor prior to the third time; and based on the second signal, continue to generate the video clip until a fourth time after the third time.

According to another embodiment of the present disclosure, a dashboard camera comprises: a mount for affixing the camera to one of a dashboard and a windscreen; a video camera; a sensor; a processor; and a memory. The memory stores instructions for execution by the processor that, when executed by the processor, cause the processor to: continuously record video using the video camera while the dashcam is powered on; store the continuously recorded video in a first portion of the memory; detect a signal from the sensor; create, based on the signal and from the continuously recorded video, a video clip; and store the video clip in a second portion of the memory.

The sensor may be an optical sensor. The mount may be configured to affix the camera to the dashboard, and the sensor may be positioned on top of the camera. The mount may be configured to affix the camera to the windscreen, and the sensor may be positioned on the bottom of the camera. The dashboard camera may further comprise an indicator light, and the memory may store additional instructions for execution by the processor that, when executed by the processor, cause the processor to illuminate the indicator light upon detection of the signal from the sensor. The dashboard camera may further comprise a wireless transceiver, and the memory may store additional instructions for execution by the processor that, when executed by the processor, cause the processor to transmit the video clip via the wireless transceiver.

A dashcam according to another embodiment of the present disclosure comprises: a video camera; an LED light; a touchless sensor; a processor; and a memory storing at least one adjustable setting and instructions for execution by the processor that, when executed by the processor, cause the processor to: activate the video camera to continuously record video; store the continuously recorded video in the memory; receive a signal from the touchless sensor; in response to the signal from the touchless sensor and based on the at least one adjustable setting, generate a video clip from the continuously recorded video; and save the video clip to the memory.

The at least one adjustable setting may define a beginning time for the video clip in relation to a time at which the signal is received from the touchless sensor. The memory may store additional instructions for execution by the processor that, when executed by the processor, cause the processor to illuminate the LED light in response to receiving the signal. The memory may be partitioned into a first portion and a second portion, the continuously recorded video may be stored in the first portion, and the video clip may be stored in the second portion.

The terms “memory,” “computer-readable medium” and “computer-readable memory” are used interchangeably and, as used herein, refer to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable medium is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y-Yₘ, and Z₁-Z₀, the phrase is intended to refer to a single element selected from X, Y, and Z, a combination of elements selected from the same class (e.g., X₁ and X₂) as well as a combination of elements selected from two or more classes (e.g., Y₁ and Z₀).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 depicts a dashboard camera according to one embodiment of the present disclosure;

FIG. 2 is a block diagram of a dashboard camera according to another embodiment of the present disclosure; and

FIG. 3 depicts a system according to another embodiment of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

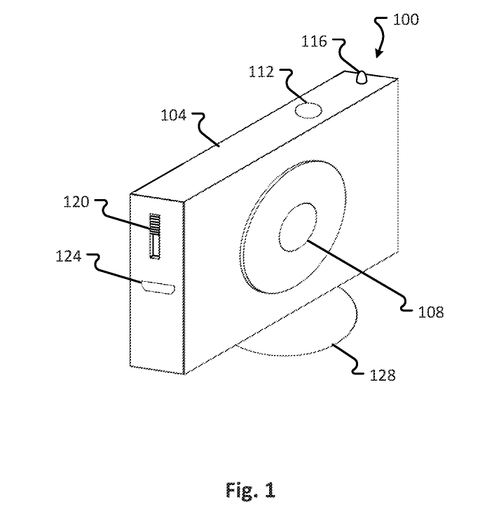

Referring first to FIG. 1, a dashcam 100 comprises a housing 104 and a lens 108 for a video camera contained within the housing 104. The lens 108 may comprise one or more filters or coatings for improving the quality of the recorded video. Such filters or coatings may be or include, for example, one or more of a polarizing or glare filter, a UV or haze filter, and a skylight filter. In some embodiments, the lens 108 may be a prime lens, with a fixed focal length, while in other embodiments the lens 108 may be a zoom lens, with an adjustable focal length. In the latter instance, the focal length may be manually or automatically adjustable. The lens 108 may be a wide-angle lens.

The dashcam 100 further comprises a user interface 120, which may comprise, for example, an on/off switch; one or more switches, buttons, or other mechanisms for adjusting one or more settings of the dashcam 100; a display for watching video recorded by the dashcam 100; and/or a touchscreen for both displaying information and/or recorded video to a user of the dashcam 100 and for receiving user input related to control of the dashcam 100 and/or its features. Settings that may be adjustable via such a user interface 120 include, for example, settings related to operation of the dashcam 100 (including in particular settings related to the operation of the video camera of the dashcam 100); settings regarding when the dashcam 100 will automatically commence recording and when the dashcam 100 will automatically stop recording; settings regarding whether and when the dashcam 100 will apply one or more electronic filters to a recorded image; and settings regarding how the dashcam 100 will respond to the detection of certain external conditions via the sensor 112 and/or other sensors. The user interface 120 may also be used to configure one or more wired or wireless transceivers and/or to set or adjust one or more wired or wireless communication settings.

One or more ports 124 may also be provided with the dashcam 100. The ports 124 may comprise, for example, a power port through which primary power (e.g. power necessary for operation of the dashcam 100) is received; a recharging port through which power is received for charging a battery or other electricity storage source, whether the battery or other electricity storage source is used for primary or backup power; and/or a wired communications port via which electronic data may be sent and/or received. Such data may include, for example, display data that may be provided to a television, monitor, or other display so as to display video recorded by the dashcam 100 on the connected display. Additionally or alternatively, such data may include data corresponding to recorded video, which data may be transferred to an external storage device for long-term storage, or so that the recorded video may be shared with others or otherwise made available for viewing. In some embodiments, a port 124 may be used to connect a mobile device or other computing device to the dashcam 100, which mobile device or other computing device may be useful for configuring the dashcam 100, setting or adjusting one or more settings of the dashcam 100, and/or accessing videos stored in the memory of the dashcam 100.

One drawback of existing dashcams is that they are configured to continuously record over previously recorded video. As a result, if a vehicle operator or other dashcam user wishes to save a portion of recorded video from being recorded over, the user has to stop recording and download the video before the dashcam has run long enough to record over the desired portion of video. For example, if a dashcam is equipped to store 30 minutes of recorded video, any video recorded before the most recently recorded 30 minutes of video will be overwritten or otherwise deleted or recorded over, and will no longer be available. When a significant event occurs (e.g. if the vehicle is involved in an accident or a road rage incident), then the inconvenience of stopping the dashcam to save the video of the accident or incident before it is overwritten is generally outweighed by the value of the video footage of the accident or incident. However, if a vehicle operator sees (and the dashcam 100 records) an item of interest while driving, but the item of interest is not related to an accident or incident of which video footage would be valuable, then the inconvenience of stopping the video recording so as to preserve the footage in question may outweigh the value of the video footage. Moreover, if the vehicle operator must continue to operate the vehicle after observing the item of interest, then the vehicle operator may desire to continue recording in case a more significant accident or incident occurs, even though doing so will result in the footage of the item of interest being lost.

The present disclosure addresses the deficiency in the prior art by including, with the dashcam 100, a sensor 112. A vehicle operator may quickly pass a hand or arm over and in relatively close proximity to the sensor 112. When the sensor 112 detects the passage of a hand or arm thereover, the sensor 112 causes the dashcam 100 to mark the time of detection and to commence a timer. Once the timer reaches a predetermined limit, the time is again marked. The dashcam 100—or more specifically a processor thereof—then snips a video clip from the recorded video based on the time of detection of the gesture by the sensor 112, and the time at which the timer expired. This video clip may then be saved (to a separate memory or memory partition relative to the continuously recorded video, in some embodiments) on the dashcam 100 for later retrieval via wired or wireless connection. The video clip also may be transmitted over a wired or wireless connection to a predetermined destination, such as a cloud storage device or an email address.

The optical sensor 112 may be provided, in some embodiments, with a relatively narrow field of view, and may further be configured with a relatively short range. These characteristics reduce the likelihood of a false triggering of the sensor 112.

Many variations on aspects of the foregoing are possible. For example, in some embodiments the dashcam 100 may be configured to start a video clip ten, fifteen, twenty, twenty-five, or thirty seconds prior to triggering of the sensor 112. This is possible because the dashcam 100 is continuously recording video, and can create the video clip from the main video recording. In some embodiments, the user can pre-select, via the user interface 120 or otherwise, whether video clips created based on triggering of the sensor 112 should begin ten, fifteen, twenty, twenty-five, or thirty seconds prior to triggering of the sensor 112. Other amounts of time may also be selected by the user, bounded only by the total length of available recording (e.g. 30 minutes, 1 hour, 90 minutes, 2 hours).

Additionally, in embodiments where a timer is used to determine where the video clip will end, the user may also be able to pre-select, via the user interface 120 or otherwise, the length of recorded video to be included in the clip after the sensor 112 is triggered. For example, a user may select a clip length of the thirty seconds, forty-five seconds, sixty seconds, or ninety seconds. Additionally, the user may select whether the selected clip length will be measured from the beginning of the clip (which may be prior to the time at which the sensor 112 is triggered), or from the time at which the sensor 112 is triggered.

In some embodiments, the user may be able to program or otherwise configure the dashcam 100 so that different indications cause the dashcam 100 to execute different sets of instructions for preparing a video clip. For example, the user may program the dashcam 100 to create a sixty-second video clip if the user passes his or her hand over the sensor 112 only once, and to create a two-minute video clip if the user passes his or hand over the sensor 112 twice in question succession. As another example, the user may program the dashcam 100 to create a video clip that starts ten seconds before the user passes his or her hand over the sensor 112 a single time, and that starts thirty seconds before the user passes his or her hand over the sensor 112 twice in quick succession. In yet other embodiments, the user may program the dashcam 100 to create a video clip that starts when the user first triggers the sensor 112 and stops when the user again triggers the sensor 112.

The sensor 112 is depicted as being on top of the dashcam 100, which is intended to be mounted on a vehicle dashboard with a suction cup mount 128. (Other types of mounts may also be used, including snap-in mounts, magnetic mounts, weighted mounts, adhesive mounts, and mechanical mounts.) In other embodiments, the dashcam 100 may be configured to be mounted on a windscreen or windshield of a vehicle, or to be suspended from a rear-view mirror of the vehicle. In such embodiments, the sensor 112 may be positioned on a bottom surface of the dashcam 100, so that a vehicle operator can pass her or his hand underneath the sensor 112. In other embodiments, the sensor 112 may be positioned on a side of the dashcam 100. In still other embodiments, the sensor 112 may be external of the housing 104, and connected to the other components of dashcam 100 via a wired connection to the port 124 or to another port. In these embodiments, the sensor 112 may be positioned in close proximity to the vehicle operator, even while the housing 104 is positioned farther away from the vehicle operator.

The sensor 112 may be any suitable type of optical sensor. A suitable type of optical sensor is any type of optical sensor that allows the sensor 112 to detect an indication from the vehicle operator. In some embodiments, the location of the sensor 112 may need to be adjusted based on the type of sensor 112 to prevent the sensor 112 from being inadvertently triggered, whether by a vehicle operator, a vehicle passenger, a shadow, or otherwise. In some embodiments, the sensor 112 may be a diffuse reflection sensor, which emits a light and detects the reflection of that light by an object.

In some embodiments, the sensor 112 may not be an optical sensor, but may instead be a different type of sensor. The sensor 112 may be, for example, an accelerometer configured to detect a tap on the housing 104. As another example, the sensor 112 may be a motion detector. In still another example, the sensor 112 may be a proximity detector. In still another example, the sensor 112 may be a pressure transducer. In some embodiments, the sensor 112 may be a microphone for detecting a spoken or other audible command, or a camera for detecting a visual command. In still other embodiments, the sensor 112 may comprise a button that, when depressed, triggers the creation of a video clip as described above. Such a button may be large in size, so as to allow the vehicle operator to easily see and press and the button and thus to reduce the amount of time the vehicle operator may be distracted from operation of the vehicle.

The dashcam 100 further comprises an LED light 116. The LED light 116 may be used, for example, to provide a visual indication that the video clip creation feature of the dashcam 100 has been triggered, and that video presently being recorded will be included in the video clip. In this manner, when the light 116 turns off, the vehicle operator will know that a new clip will need to be triggered if the operator would like to continue recording an item of interest. In some embodiments, the light 116 may flash for the last three, five, or ten seconds (or other amount of time) prior to the time when the video clip will end. This may alert the operator that the clip is about to end, and give the operator time to provide a new indication via the sensor 112. If a new indication is received by the sensor 112 during this time period, then the length of the clip may be extended by a predetermined amount of time. In some embodiments, the length of the predetermined amount of time may be selectable by providing different indications to the sensor 112 while the light 116 is flashing. For example, triggering the sensor 112 once may cause the video clip to be twice as long as the original predetermined amount of time, while triggering the sensor 112 twice in quick succession may cause the video clip to be three or four times as long as the original predetermined amount of time.

Although not shown in FIG. 1, the dashcam 100 may further comprise a mount for affixing the dashcam 100 to a dashboard or a windscreen of a vehicle. The mount may be or comprise, for example, a suction cup, a magnet, or a latching mechanism.

In some embodiments, the length of a video clip may be extended by providing a second indication via the sensor 112 anytime a video clip is currently in process, as indicated by illumination of the light 116.

As one example of the use of a dashcam 100, suppose the dashcam 100 is installed in a vehicle that is being driven from Shenzhen to Guangzhou, China. During the drive, the vehicle operator sees an interesting car in front of the vehicle, and waves her hand above the sensor 112. The light 116 illuminates and the dashcam 100 creates a video clip that begins ten seconds before the sensor 112 was triggered, and is one minute in length. (These times are based on default or preconfigured settings of the dashcam 100.) The video clip is stored in an auxiliary memory of the dashcam 100 where it will not be overwritten by the continuous video recording of the dashcam 100. Later, the vehicle operator sees a road rage incident between two third-party vehicles. This time, the driver passes her hand over the sensor 112 twice in quick succession. The light 116 again illuminates, and the dashcam 100 creates a video clip that begins thirty seconds before the sensor 112 was triggered, and is two minutes in total length. However, the road rage incident is still playing out before the vehicle operator as the end of the two minutes approaches. When the light 116 begins to flash, the vehicle operator again triggers the sensor 112. As a result, the dashcam doubles the length of the video clip to four minutes, and captures the entire road rage incident. Once the video clip is created, it is also stored in the auxiliary memory of the dashcam 100. When the vehicle operator arrives in Guangzhou, she connects the dashcam 100 to a wireless network, and the dashcam 100 uploads the stored video clips to the cloud, or sends them to the operator's email address, or both.

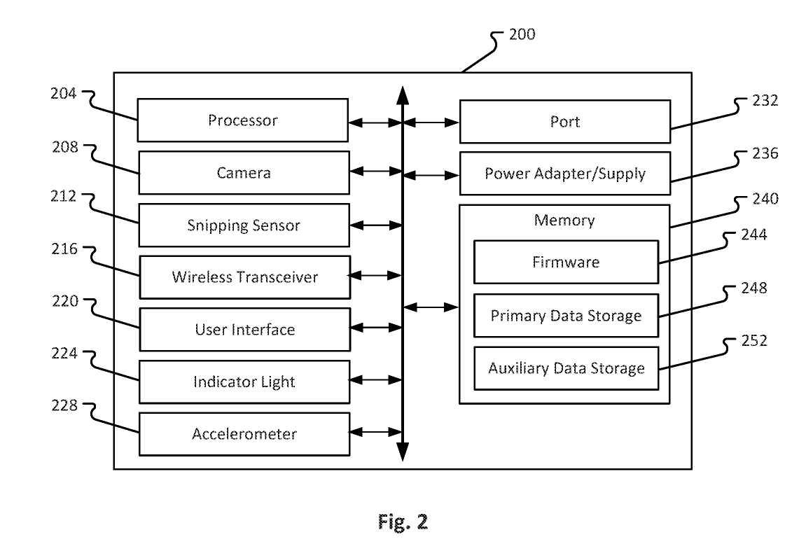

Turning now to FIG. 2, a dashcam 200 according to embodiments of the present disclosure comprises a processor 204, a camera 208, a snipping sensor 212, a wireless transceiver 216, a user interface 220, an indicator light 224, an accelerometer 228, a port 232, a power adapter/supply 236, and a memory 240. Each of these components is described below.

The processor 204 may correspond to one or multiple microprocessors that are contained within the housing 120 of the dashcam 200. The processor 204 may comprise a Central Processing Unit (CPU) on a single Integrated Circuit (IC) or a few IC chips. The processor 204 may be a multipurpose, programmable device that accepts digital data as input, processes the digital data according to instructions stored in its internal memory, and provides results as output. The processor 204 may implement sequential digital logic, as it has internal memory. As with most known microprocessors, the processor 204 may operate on numbers and symbols represented in the binary numeral system. The processor 204 may execute instructions stored in a firmware thereof, and may also execute instructions stored in the memory 240. The processor 204 may be used to control one or more aspects of one or more of the camera 208, the snipping sensor 212, the wireless transceiver 216, the user interface 220, the indicator light 224, the accelerometer 228, the port 232, and the power adapter/supply 236. The processor 204 may also be used to read data from or to write data to the memory 220.

The camera 208 is a digital video camera, and may use a CMOS image sensor or a CCD device to record video. The camera 208 may be fitted to a lens such as the lens 108. In some embodiments, the camera 208 may comprise various features known to those of skill in the art, including for example optical zoom, digital zoom, autofocus, optical aberration correction, and optical image stabilization. The camera 208 may be the same as or similar to a camera used in a mobile device. Manufacturers of such cameras include, but are not limited to, Toshiba Corp., ST Microelectronics N.V., Sharp Corp., Omnivision Technologies, Inc., and ON Semiconductor.

In some embodiments, the camera 208 may comprise a microphone or other audio transducer. The microphone may be useful, for example, to capture sound when recording a video.

The snipping sensor 212 may be the same as or similar to the sensor 112 described above.

The wireless transceiver 216 comprises hardware that allows the dashcam 200 to connect with a mobile device, such as a smartphone, tablet, or laptop, or with another computing or memory device equipped for wireless communications. The wireless transceiver 216 thus allows the dashcam 200 to connect to the Internet or another wide-area or local-area network. The wireless transceiver 216 may be used to receive software or firmware updates for the dashcam 200; to receive user input and/or commands from a mobile device or other external computing device, including to modify one or more settings of the dashcam 200; and to transmit stored video from the dashcam 200 to the cloud, to an email address, or to another destination or external storage device.

The wireless transceiver 216 comprises a Bluetooth interface. In other embodiments of the present disclosure, the wireless transceiver 216 may comprise a Wi-Fi card, a Network Interface Card (NIC), a cellular interface (e.g., antenna, filters, and associated circuitry) (such as, for example, a 3G interface, a 4G interface, or an LTE interface), a near field communication (NFC) interface, a ZigBee interface, a FeliCa interface, a MiWi interface, a Bluetooth interface, a Bluetooth low energy (BLE) interface, or the like. Regardless of the protocol used by the wireless transceiver 216, the wireless transceiver 216 may comprise, for example, a transmitter, a receiver, and an antenna, and may also comprise software or firmware needed to operate such components.

The user interface 220 may comprise one or more switches (such as the switch 120), buttons, displays, and/or other interface elements by which a user can control one or more features of the dashcam 200 and, in some embodiments, through which information may be provided by the dashcam 200 to the user. In some embodiments, for example, a slider switch may be included on the dashcam 200 as an on/off switch, e.g. for controlling the flow of electricity from the power adapter/supply 236 to the processor 204, the camera 208, the wireless transceiver 216, and/or other components of the dashcam 200. The user interface 220 may further comprise one or more buttons, slider bars, other physical switches, or virtual controls (provided via a display) for controlling such aspects of the operation of the dashcam 200 as pairing or otherwise connecting the dashcam 200 to an external device via the wireless transceiver 216; zooming in or out with optical or digital zoom; turning image stabilization features on or off; and selecting whether to use a display, a connected mobile device, or both as a viewfinder. In some embodiments, the user interface 212 may comprise one or more LED lights on a housing of the camera 200, which may illuminate in various patterns or sequences as controlled by the processor 204 to communicate various pieces of information to a user of the dashcam 200.

Although the foregoing description refers primarily to slider switches, buttons, and displays, any input devices may be included in the user interface 220 and used to control the functions of the dashcam 200, including switches, slider bars, toggles, rocker switches, rotary switches, rheostats, and potentiometers. The user interface 220 may comprise a keyboard. Additionally, non-mechanical input devices may be used instead of or in addition to mechanical devices. For example, the user interface 220 may comprise one or more touchscreens, which may display a plurality of virtual switches or controls. Similarly, the user interface 220 may include any output device, including but not limited to a screen and LED lights, for conveying relevant information from the dashcam 200 to a user thereof.

The indicator light 224 may be the same as or substantially similar to the light 116 described above. In some embodiments, the indicator light 224 may be a different type of light than an LED light. The indicator light 224 may emit light of only one color, or it may emit light of a plurality of colors. The indicator light 224 may be used only to indicate when a video clip is being created (and, in some embodiments, to indicate when the end of the video clip is approaching), or it may also be used as part of the user interface 220 to provide additional indications to a user of the dashcam 200. In embodiments where the indicator light 224 emits a plurality of colors, different colors may be used to indicate different things to the user of the dashcam 200. For example, a green light may indicate that the dashcam 200 is powered on and recording video, while a red light may indicate that a video clip is being created.

The dashcam 200 also comprises an accelerometer 228. The accelerometer 228, which may not be the snipping sensor 212, may be configured to detect high g-force events, such as a collision or other accident involving the vehicle in which the dashcam 200 is installed. When such an event is detected, the resulting signal sent by the accelerometer 228 to the processor 204 may cause the processor 204 to stop recording video, or to record video for only an additional predetermined period of time (e.g. 1 minute, or 2 minutes, or 3 minutes, or 5 minutes), so that any video of the event captured by the dashcam 200 is preserved, instead of being written over by a new recording. In some embodiments, the accelerometer 228 may also serve as the snipping sensor 212. In such embodiments, the accelerometer 228 may send a signal to the processor 204 when the accelerometer 228 is tapped. The processor 204 may, in turn, be programmed to distinguish the tapping signal from other signals generated by the accelerometer 228, and to create a video clip upon detection of such a tapping signal. However, in such embodiments, the accelerometer 228 may still be configured to send a different signal to the processor 204 when a high g-force event is detected, which signal may still cause the processor 204 to stop recording video with the camera 208 once a predetermined amount of time has passed.

The port 232 may have one or more functions, including as a power port for connecting the dashcam 100 to an external power source (whether for powering normal operation of the dashcam 100 or for charging/recharging a battery of the dashcam 100), or for connecting a mobile device or an external storage device to the dashcam 100 (e.g. to download or otherwise offload videos from the dashcam 100, or for gaining access to additional controls and/or settings for the dashcam 100 via a connected mobile device, or to enable the dashcam 100 to access the Internet through a wireless transceiver of a connected mobile device). The port 232 may be a USB port, a Lightning port, a Firewire port, an Ethernet port, or any other port through which data and/or power may be transferred. Where the USB protocol is used, the port 232 may be one or more of Type A, Type B, Mini-A, Mini-B, Micro-A, and/or Micro-B ports. Additionally, the dashcam 100 may in some embodiments comprise a plurality of ports 232, which may be identical to or different from each other. The port 232 may be the same as or similar to the port 124 described in connection with FIG. 1 above.

The power adapter/supply 236 may comprise circuitry for receiving power from an external source and accomplishing any signal transformation, conversion or conditioning needed to provide an appropriate power signal to the processor 204, the camera 208, and the other powered components of the dashcam 200. An external power source may be connected to the power adapter/supply 236 via the port 232 or via a dedicated power port of the power adapter/supply 236. Additionally or alternatively, the power adapter/supply 236 may comprise one or more batteries for supplying needed power to the dashcam 200. Such batteries may be used for normal operation, or such batteries may provide backup power (e.g. when power from an external source is not available). In embodiments comprising one or more batteries, the batteries may be removable and replaceable, and/or the batteries may be rechargeable. In embodiments with rechargeable batteries, the dashcam 200 may utilize the port 232 as a power inlet port, or the power adapter/supply 236 may comprise a dedicated charging port for recharging rechargeable batteries contained therein.

The memory 240 may comprise a firmware section 244, a primary data storage section 248, and an auxiliary data storage section 252. The memory 240 may correspond to any type of non-transitory computer-readable medium. In some embodiments, the memory 240 may comprise volatile or non-volatile memory and a controller for the same. Non-limiting examples of memory 240 that may be utilized in the dashcam 200 include RAM, ROM, buffer memory, flash memory, solid-state memory, or variants thereof.

The firmware section 244 may store any electronic data (including instructions) needed for operation of the dashcam 200. For example, the memory 240 may store any firmware needed for allowing the processor 204 to operate and/or communicate with the various components of the dashcam 200, as needed, and to communicate with one or more mobile devices or other computing devices connected to the dashcam 200 via the wireless transceiver 216 or the port 232.

The primary data storage section 248 may be used to store the continuously recorded video captured by the camera 208. The primary data storage section 248 therefore may be sized to store a predetermined amount of video, corresponding to a video length of thirty minutes, or one hour, or ninety minutes, or two hours, or any other desired video length. The primary data storage section 248 may therefore be continuously being rewritten, as newly recorded video may be recorded over previously recorded video once the primary data storage section 248 reaches full capacity. A user of the dashcam 200 may, however, cause the contents of the primary data storage section 248 to be downloaded to a mobile device or external storage device connected to the dashcam 200 via the wireless transceiver 216 or the port 232, or to be uploaded to the cloud via the wireless transceiver 216, when so desired.

The auxiliary data storage section 252 may be used to store video clips in a location where they will not be overwritten by the continuous rewriting of video to the primary data storage section 248. The auxiliary data storage section 252 may be sized to store only a few video clips (e.g. to store data corresponding to a length of video that is much shorter than the length of video that may be stored by the primary data storage section), or the auxiliary data storage section 252 may be sized to store many video clips, corresponding to a length of video approximately equal to or even longer than the length of video that may be stored in the primary data storage section.

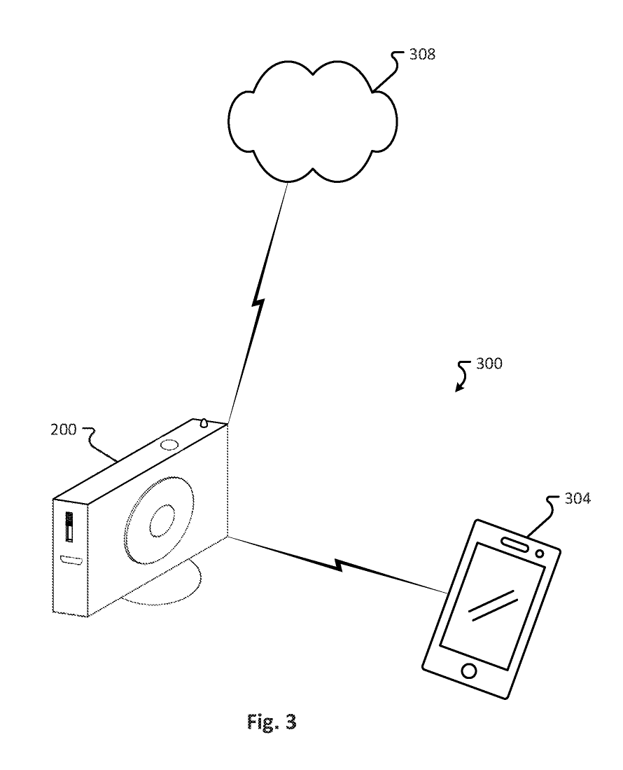

With reference now to FIG. 3, a dashcam 200 may be configured to wirelessly connect to a mobile device 304, whether to receive settings and configuration information from the mobile device 304, to download recorded video and/or video clips to the mobile device 304, or both. The dashcam 200 may also be configured to connect wirelessly to the cloud 308, for uploading recorded video to the cloud for long-term storage, to make the video available for viewing, or otherwise.

In some embodiments, the dashcam 200 may be configured to establish a Bluetooth or other peer-to-peer connection with a mobile device 304, while the dashcam 200 is being used. In such embodiments, the dashcam 200 may be configured to download video clips to the mobile device 304 and/or to upload video clips to the cloud 308 as soon as the video clips have been made. In other embodiments, where the wireless transceiver 216 of the dashcam 200 comprises a cellular interface, the dashcam 200 may be able to upload video clips to the cloud without connecting to another mobile device, and may further be able to send emails to which recorded video clips are attached without connecting to another mobile device.

A number of variations and modifications of the foregoing disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A10 Fusion processor with 64-bit architecture, Apple® M10 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, and ARM® Cortex-A and ARM926EJ-S™ processors. A processor as disclosed herein may perform computational functions using any known or future-developed standard, instruction set, libraries, and/or architecture.

I claim:

1. A dashcam comprising:
a video camera;
a snipping sensor;
a wireless transceiver;
a processor; and
a memory having a primary data storage section and an auxiliary video storage section, the memory also storing instructions for execution by the processor that, when executed by the processor, cause the processor to:
continuously operate the video camera to record video when the dashcam is powered on;
store the continuously recorded video in the primary data storage section;
receive a signal from the snipping sensor at a first time;
generate, from the continuously recorded video and beginning at a second time based on the first time, a video clip; and
store the video clip in the auxiliary video storage section.

2. The dashcam of claim 1, wherein the memory stores additional instructions for execution by the processor that, when executed by the processor, cause the processor to transmit the stored video clip via the wireless transceiver.

3. The dashcam of claim 1, wherein the memory stores additional instructions for execution by the processor that, when executed by the processor, cause the processor to overwrite previously recorded video with recently recorded video in the primary data storage section when the primary data storage section is full.

3. The dashcam of claim 1, wherein the video clip ends a predetermined length of time after the first time.

4. The dashcam of claim 1, wherein the memory stores additional instructions for execution by the processor that, when executed by the processor, cause the processor to:
receive a second signal from the snipping sensor at a third time later than the first time and the second time; and
end the video clip at the third time.

5. The dashcam of claim 1, wherein the second time is before the first time.

6. The dashcam of claim 1, further comprising an accelerometer.

7. The dashcam of claim 1, further comprising an indicator light.

8. The dashcam of claim 7, wherein the memory stores additional instructions for execution by the processor that, when executed by the processor, cause the processor to illuminate the indicator light upon receipt of the signal.

9. The dashcam of claim 8, wherein the memory stores additional instructions for execution by the processor that, when executed by the processor, cause the processor to cause the indicator light to flash for a predetermined period of time prior to a third time that is after the first time and the second time.

10. The dashcam of claim 9, wherein the memory stores additional instructions for execution by the processor that, when executed by the processor, cause the processor to:
receive a second signal from the snipping sensor prior to the third time; and
based on the second signal, continue to generate the video clip until a fourth time after the third time.

11. A dashboard camera, comprising:
a mount for affixing the camera to one of a dashboard and a windscreen;
a video camera;
a sensor;
a processor; and
a memory, the memory storing instructions for execution by the processor that, when executed by the processor, cause the processor to:
continuously record video using the video camera while the dashcam is powered on;
store the continuously recorded video in a first portion of the memory;
detect a signal from the sensor;
create, based on the signal and from the continuously recorded video, a video clip; and
store the video clip in a second portion of the memory.

12. The dashboard camera of claim 11, wherein the sensor is an optical sensor.

13. The dashboard camera of claim 11, wherein the mount is configured to affix the camera to the dashboard, and the sensor is positioned on top of the camera.

14. The dashboard camera of claim 11, wherein the mount is configured to affix the camera to the windscreen, and the sensor is positioned on the bottom of the camera.

15. The dashboard camera of claim 11, further comprising an indicator light, and wherein the memory stores additional instructions for execution by the processor that, when executed by the processor, cause the processor to illuminate the indicator light upon detection of the signal from the sensor.

16. The dashboard camera of claim 15, further comprising a wireless transceiver, and wherein the memory stores additional instructions for execution by the processor that, when executed by the processor, cause the processor to transmit the video clip via the wireless transceiver.

17. A dashcam comprising:
a video camera;
an LED light;
a touchless sensor;
a processor; and
a memory storing at least one adjustable setting and instructions for execution by the processor that, when executed by the processor, cause the processor to:
activate the video camera to continuously record video;
store the continuously recorded video in the memory;
receive a signal from the touchless sensor;
in response to the signal from the touchless sensor and based on the at least one adjustable setting, generate a video clip from the continuously recorded video; and
save the video clip to the memory.

18. The dashcam of claim 17, wherein the at least one adjustable setting defines a beginning time for the video clip in relation to a time at which the signal is received from the touchless sensor.

19. The dashcam of claim 17, wherein the memory stores additional instructions for execution by the processor that, when executed by the processor, cause the processor to illuminate the LED light in response to receiving the signal.

20. The dashcam of claim 17, wherein the memory is partitioned into a first portion and a second portion, and further wherein the continuously recorded video is stored in the first portion and the video clip is stored in the second portion.
